(19) United States
(12) Patent Application Publication
(10) Pub. No.: US 2022/0207638 A1
(43) Pub. Date: Jun. 30, 2022

(54) METHOD AND SYSTEM TO FACILITATE ACCESS TO AND USE OF CONTEXTUAL IDENTITY INFORMATION DURING LAW ENFORCEMENT ENCOUNTERS FOR MINIMIZING CONFRONTATIONAL TENSIONS

(71) Applicants: Mary D. Jackson, Cordova, TN (US); Brenton Mohair, Olive Branch, MS (US); Brian Simons, Medina, MN (US); Damon Willis, Smyrna, GA (US); Chapelle Riggins, Cordova, TN (US)

(72) Inventors: Mary D. Jackson, Cordova, TN (US); Brenton Mohair, Olive Branch, MS (US); Brian Simons, Medina, MN (US); Damon Willis, Smyrna, GA (US); Chapelle Riggins, Cordova, TN (US)

(21) Appl. No.: 17/566,304

(22) Filed: Dec. 30, 2021

Related U.S. Application Data
(60) Provisional application No. 63/132,422, filed on Dec. 30, 2020.

(51) Int. Cl. G06Q 50/26; G06F 16/2457

(52) U.S. Cl. CPC G06Q 50/265; G06F 16/24575

(57) ABSTRACT

A system and a method facilitating access to and use of contextual identity information during law enforcement encounters for minimizing confrontational tensions are disclosed. A user updates information corresponding to a user, his/her associates, and a vehicle or dwelling on a government server and an insurance server. A law enforcement official uses a law enforcement device to access the government server, the insurance server, and a law enforcement server. The law enforcement official accesses the government server, the law enforcement server, and the insurance server to verify the identification of the user and the vehicle or dwelling. The system allows the law enforcement official to have required information on the law enforcement device to verify the identification of the user and the vehicle/dwelling. The law enforcement official verifies the identification at ease thereby reducing potential hostile situations with the user.

The present application claims the benefit of U.S. Provisional Application No. 63/132,422, filed Dec. 30, 2020; all of which is incorporated herein by reference.

### FIELD OF THE INVENTION

The present subject matter generally relates to verifying the identity of users during law enforcement encounters. More specifically, the present subject matter relates to a system and method facilitating access to law enforcement officers to access contextual information of users during law enforcement encounters for minimizing confrontational tensions with the users in a variety of scenarios including, for example moving vehicle law-enforcement encounters, private residence law enforcement encounters, and other situations where a law enforcement officer could use additional, timely information relating to the particular suspect.

### BACKGROUND OF INVENTION

Law enforcement officers such as police often face dangerous situations in maintaining law and order. At times, law enforcement officers face dangerous situations due to a lack of appropriate information. For example, consider that a law enforcement officer stops a vehicle at the side of the road to verify the identification of a driver and/or the vehicle. Typically, the law enforcement officer verifies the vehicle identification using the vehicle's licence plate number. However, there is no mechanism available that allows the law enforcement officer to verify who is actually driving the vehicle or what is happening in the vehicle until the law enforcement officer approaches the vehicle. Once the law enforcement officer approaches the vehicle, a user or driver may panic due to uncertainty on adverse actions of the law enforcement officer. The law enforcement officer too may act suspicious and proceed cautiously. The above may lead to poor relations between the law enforcement officer and the driver.

Further, the law enforcement officer may confront the driver and use force to arrest the driver. Further, the law enforcement officer may abuse and use racial slurs to intimidate the driver. Many such situations quickly get escalated and result in the law enforcement officer fatally shooting down the driver.

In a similar or related scenario, frequently law enforcement officers need to approach dwellings, such as apartments and other residences, not knowing much about the occupants inside the dwelling at the time, and their state of mind. What is law-enforcement officers know is that they have a search warrant, which may be a no-knock search warrant, and that there is a troubling scenario relating to the dwelling. Because they do not know the person or the condition of the person on the other side of the door on which they are knocking, tensions can escalate rapidly.

In order to reduce such situations, authorities install body-worn cameras to monitor the behaviour of law enforcement officers and drivers. However, they do not prevent or minimize confrontational tensions between law enforcement officers and drivers.

Therefore, there is a need for a system facilitating access to law enforcement officers to access contextual information of users during law enforcement encounters for minimizing confrontational tensions with the users.

### SUMMARY

It is an object of the present subject matter to provide a system facilitating access to law enforcement officers to access contextual information of users during law enforcement encounters for minimizing confrontational tensions with the users and that avoids the drawback of known techniques.

It is a further object of the present subject matter to provide a system facilitating access by law enforcement officers of dwellings and residences in a manner that prevents rapid escalation of tensions that may lead to lethal encounters for both the law enforcement officers and the residence of such dwellings.

It is another object of the present subject matter to provide a system linked to law enforcement, insurance, and government databases or servers to provide instant identification of the user(s) of a vehicle to minimize confrontational tensions between a law enforcement officer and a user.

In order to achieve one or more objects, the present subject matter provides a system that allows a user or driver to update his, and his associate's information and vehicle and dwelling information with a government server and an insurance server. User information and vehicle information such as DMV information, vehicle registration details, insurance details, and law enforcement information is updated in real-time with the government server and the insurance server. A law enforcement officer uses a law enforcement device to access the government server, the insurance server, and a law enforcement server. Specifically, the law enforcement officer uses the law enforcement device when he/she pulls over the user at the side of the road to verify the identification of the user or request that the residence occupied open the door to the residence. The law enforcement officer accesses information of the user and vehicle to identify the user.

In one advantageous feature of the present subject matter, the system provides the information to the law enforcement officer and allows to reduce potentially hostile situations, by putting the law enforcement official at ease. The system provides complete information about the user to the law enforcement official and helps to reduce the initial confrontational tension between the law enforcement officer and the user. This results in the user or driver/resident a likelihood of putting the law enforcement official in a potentially dangerous situation. Further, this causes the law enforcement official to be less likely to harm the user/driver/resident.

Features and advantages of the subject matter hereof will become more apparent in light of the following detailed description of selected embodiments, as illustrated in the accompanying FIGURES. As will be realised, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

Further features and advantages of the present subject matter will become apparent from the following detailed description, taken in combination with the appended drawings, in which:

FIG. 1 illustrates an exemplary network communications system, in accordance with one embodiment of the present subject matter;

FIG. 2 illustrates a diagrammatic representation of the system, in accordance with one embodiment of the present subject matter;

FIG. 3 illustrates a method of updating details of the user and the vehicle at government server, law enforcement server, and insurance server, in accordance with one embodiment of the subject matter;

FIGS. 4 through 8 illustrate exemplary interfaces presented on a client device, in accordance with one embodiment of the subject matter;

FIG. 9 illustrates information flow between one or more entities, in accordance with one embodiment of the subject matter; and

FIG. 10 illustrates a method of accessing contextual identity information during law enforcement encounters by a law enforcement officer using a law enforcement device, in accordance with one embodiment of the subject matter.

It will be noted that throughout the appended drawings, like features are identified by like reference numerals.

### DETAILED DESCRIPTION OF THE EMBODIMENTS

Before the present features and working principle of a system for facilitating access to and use of contextual identity information during law enforcement encounters for minimizing confrontational tensions is described, it is to be understood that this subject matter is not limited to the particular system as described, since it may vary within the specification indicated. Various features for facilitating access to and use of contextual identity information during law enforcement encounters for minimizing confrontational tensions might be provided by introducing variations within the components/subcomponents disclosed herein. It is also to be understood that the terminology used in the description is for the purpose of describing the particular versions or embodiments only, and is not intended to limit the scope of the present subject matter, which will be limited only by the appended claims. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It should be understood that the present subject matter describes a system and method of facilitating access to and use of contextual identity information during law enforcement encounters for minimizing confrontational tensions access to and use of contextual identity information during law enforcement encounters for minimizing confrontational tensions. The system provides the information to the law enforcement officer and allows to reduce potentially hostile situations, by putting the law enforcement official at ease. The system provides complete information about the users to the law enforcement official and helps to reduce the initial confrontational tension between the law enforcement officer and the users.

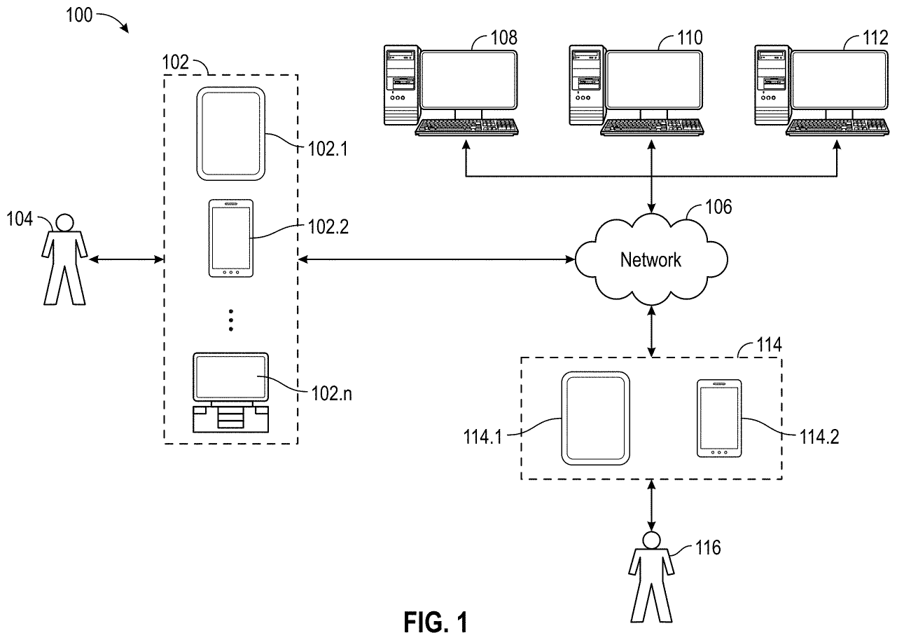

Various features and embodiments of the system for facilitating access to and use of contextual identity information during law enforcement encounters for minimizing confrontational tensions are explained in conjunction with the description of FIGS. 1-10.

The present subject matter discloses a system for facilitating access to and use of contextual identity information during law enforcement encounters for minimizing confrontational tensions. The system may be realised in a network communications system. FIG. 1 shows a high-level block diagram of an exemplary network communications system 100, in accordance with one embodiment of the present subject matter. For ease of reference, network communications system 100 is referred to as system 100 throughout the description. System 100 includes one or more client devices such as client device 102.1, client device 102.2 . . . client device 102.n, collectively referred as client devices or simply client device 102. Client device 102 indicates an electronic device such as a mobile device, a personal digital assistant, a laptop computer, a tablet computer, a desktop computer etc. In the present subject matter, user 104 of a vehicle operates client device 102. Here, user 104 indicates an individual who is an owner of a vehicle or another individual authorized by the owner to operate the vehicle or occupant who is authorized to reside in the dwelling. For example, owner 104 operates client device 102.1 and his daughter 104 operates client device 102.2. The vehicle includes, but limited to, a motorized and a non-motorized vehicle. Further, the vehicle includes, a land-based vehicle such as a car, truck, etc., or a water-based vehicle such as a boat, a personal watercraft, etc., as well as an apartment/home that the law-enforcement officer my approach.

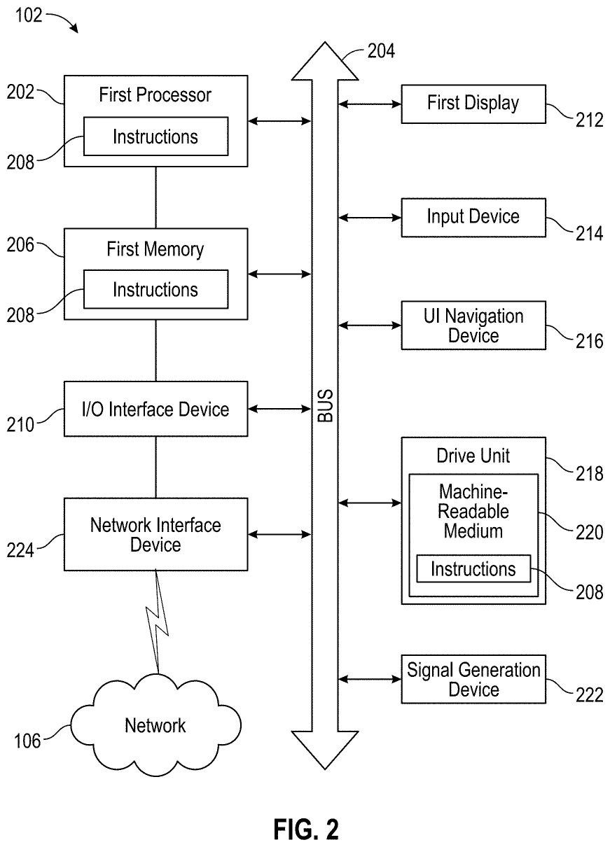

FIG. 2 shows a diagrammatic representation of client device 102, in accordance with one embodiment of the present subject matter. Client device 102 encompasses first processor 202 (e.g., a central processing unit (CPU), a graphics processing unit (GPU), or both). First processor 202 electrically couples by a data bus 204 to a first memory 206. First memory 206 includes volatile memory and/or non-volatile memory. Preferably, first memory 206 stores instructions or software program 208 that interact with the other devices in client device 102 and/or system 100 as described below. In one implementation, first processor 202 executes instructions 208 stored in first memory 206 in any suitable manner. In one implementation, first memory 206 stores digital data indicative of documents, files, programs, web pages, etc. retrieved from one of host device 108, server 110, and input device 214.

Client device 102 further includes first display 212 (e.g., a liquid crystal display (LCD) or a cathode ray tube (CRT)). Client device 102 includes input device (e.g., a keyboard) and/or touchscreen 214, user interface (UI) navigation device 216 (e.g., a mouse), drive unit 218, signal generation device 222 (e.g., a speaker), and a network interface device 224.

Drive unit 218 includes machine-readable medium 220 on which one or more sets of instructions and data structures (e.g., software 208) is stored. It should be understood that the term “machine-readable medium” includes a single medium or multiple medium (e.g., a centralised or distributed database, and/or associated caches and servers) that stores one or more sets of instructions. The term “machine-readable medium” also includes any medium that is capable of storing, encoding, or carrying a set of instructions for execution by the machine and that cause the machine to perform any one or more of the methodologies of the present subject matter, or that is capable of storing, encoding or carrying data structures utilised by or associated with such a set of instructions. The term “machine-readable medium” accordingly includes, but not be limited to, solid-state memories, optical and magnetic media, and carrier wave signals.

Instructions 208 reside, completely or at least partially, within first memory 206 and/or within first processor 202 during execution thereof by client device 102. Network interface device 224 transmits or receives instructions 208 over network 106 utilising any one of a number of well-known transfer protocols.

Network 106 includes a wireless network, a wired network or a combination thereof. Network 106 can be implemented as one of the different types of networks, such as intranet, local area network (LAN), wide area network (WAN), the internet, and the like. Network 106 implements as a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, network 106 includes a variety of network devices, including routers, bridges, servers, computing devices, storage devices, and the like.

Client device 102 communicates with government server 108, law enforcement server 110, and insurance server 112. In one implementation, government server 108 indicates a server or database owned and operated by county, city, state, or federal government. Government server 108 stores personal details and/or social security number to identify and maintain records of user(s) 104. In one example, government server 108 receives and stores data from a department of motor vehicles (DMV) (from local, state, and federal databases). Further, government server 108 stores vehicle registration details. Law enforcement server 110 includes a server or database operated by a law enforcement authority such as local police, federal police, department of justice, etc. Law enforcement server 110 stores crime records, traffic offences, law violation records, etc. Law enforcement server 110 receives information from a variety of sources including, but not limited to, local police, federal police, department of justice, people making distress calls or reporting a crime/grievance by calling 911, etc.

Insurance server 112 indicates a server or database operated by a government or privately owned organization. Insurance server 112 stores information corresponding to the insurance obtained by the user and/or for the vehicle. Insurance server 112 stores information such as the name of the insurer, identification details of the vehicle, validity i.e., proof of the insurance, health information (medical conditions, images of medicines, prescription, etc) of user 104 and other authorised users, etc.

Each of government server 108, law enforcement server 110, and insurance server 112 includes an electronic device such as a mobile device, a personal digital assistant, a laptop computer, a tablet computer, a desktop computer, etc. Each of government server 108, law enforcement server 110, and insurance server 112 store one or more of a plurality of files, programs, databases, and/or web pages in one or more memories for use by client device(s) 102. A person skilled in the art appreciates that each of government server 108, law enforcement server 110, and insurance server 112 may be configured according to its particular operating system, applications, memory, hardware, etc., and may provide various options for managing the execution of the programs and applications, as well as various administrative tasks. In one implementation, each of government server 108, law enforcement server 110, and insurance server 112 are operated by separate and distinct entities that interact together according to some agreed-upon protocol. In another embodiment, each of government server 108, law enforcement server 110, and insurance server 112 are operated by the same entity.

Further, one or more law enforcement personnel operate law enforcement device 114.1, law enforcement device 114.12, collectively referred as law enforcement device 114. Law enforcement device 114 indicates an electronic device such as a mobile device, a personal digital assistant, a laptop computer, a tablet computer, a desktop computer, etc. In the current embodiment, law enforcement officer 116 e.g., a police officer operates law enforcement device 114.

The present description is explained considering that client device 102 updates information corresponding to user 104 and his vehicle to each of government server 108, law enforcement server 110, and insurance server 112. Government server 108, law enforcement server 110, and insurance server 112 store the information and allow law enforcement officer 116 to access the information using law enforcement device 114.

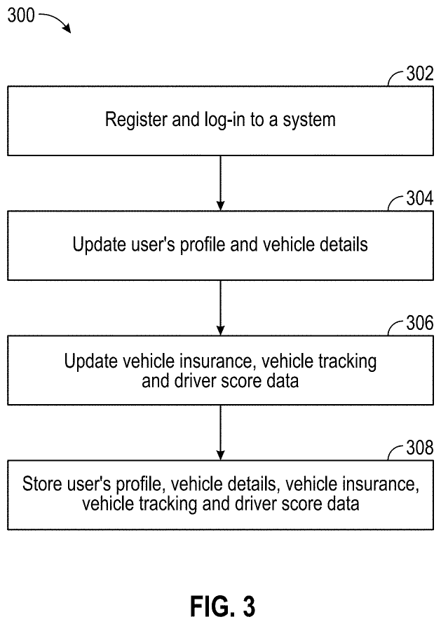

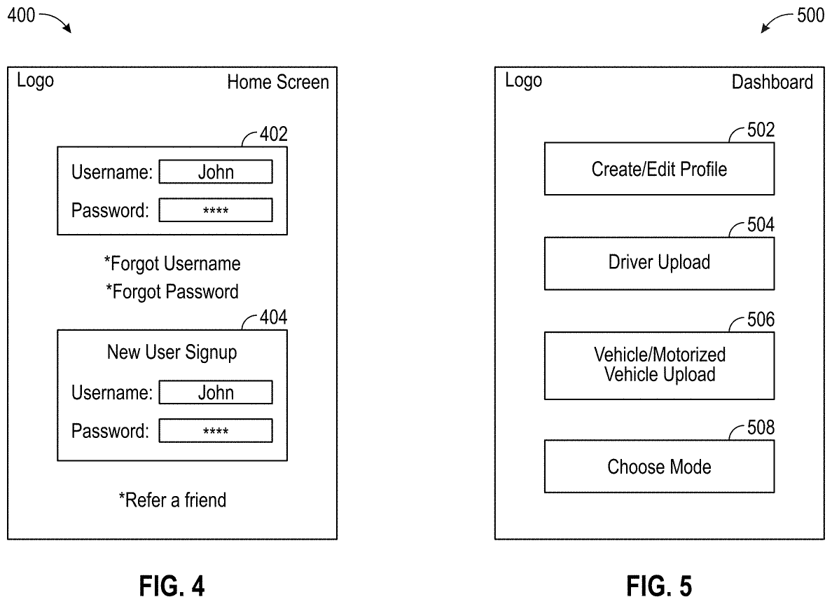

FIG. 3 illustrates method 300 of updating details of user 104 and the vehicle at government server 108, law enforcement server 110, and insurance server 112, in accordance with one exemplary embodiment of the present subject matter. The order in which method 300 is described should not be construed as a limitation, and any number of the described method blocks can be combined in any order to implement method 300 or alternate methods. Additionally, individual blocks may be deleted from method 300 without departing from the spirit and scope of the subject matter described herein. Furthermore, method 300 can be implemented in any suitable hardware, software, firmware, or combination thereof. However, for ease of explanation, in the embodiments described below, method 300 may be implemented using the above-described system 100. Method 300 is explained in conjunction with exemplary interfaces illustrated in FIGS. 4 through 8.

A person skilled in the art understands that client device 102 incorporates an application or specifically configured program to communicate with each of government server 108 and insurance server 112. In order to provide details of user 14 and his/her vehicle details to government server 108 and insurance server 112, at first, the user registers (step 302) with each of government server 108 and insurance server 112. FIG. 4 illustrates an exemplary interface 400 presented to user 104 on client device 102 sign-in or sign-up with government server 108 and insurance server 112. Interface 400 includes a first section 402 and second section 404. If user 102 is already registered with government server 108 and insurance server 112, then first section 402 prompts user 104 to input his username and password. If user 104 is not registered, then client device 102 prompts user 104 to sign up or register by providing his name and password in second section 402. After registering, client device 102 prompts user 104 to provide his/her details and vehicle details.

FIG. 5 shows an exemplary interface 500 presented to user 104 on client device 102 for providing his/her details and vehicle details (step 304). Interface 500 includes first section 502, second section 504, third section 506, and fourth section 508. First section 502 presents an option for a user to create or edit a profile of himself or for other users who will be using the vehicle. For example, consider user 104 is a father. As such, user 104 creates a profile for himself. Further, user 104 creates profiles for other users i.e., family members or friends by providing their names and other identification details. Second section 504 presents an option for user 104 to provide details of himself or others who are authorised to drive his vehicle. Third section 506 presents an option to provide details of the vehicle. For example, consider user has a JeepTM. For the vehicle, user 104 provides vehicle details such as make, model, chassis number, number plate, insurance provider name, policy number, policy coverage, etc. In one example, user 104 provides information corresponding to licenses and permits for hunting, fishing, camping; licenses, permits, and identification information for outdoor activities; licenses, permits, and identification information for people and pets. Fourth section 508 presents different modes in which user 104 can operate application and/or client device 102.

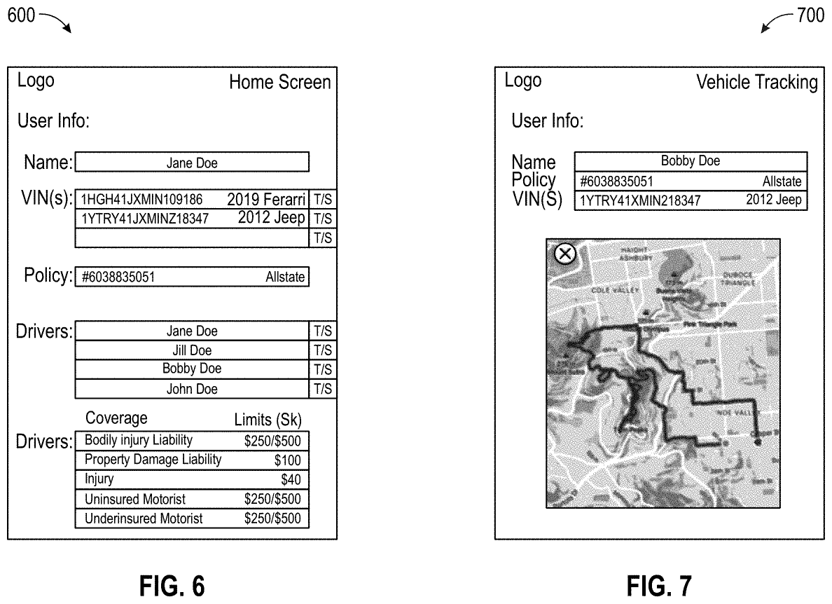

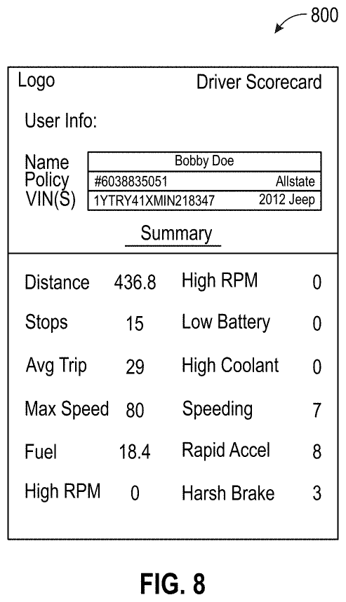

As specified above, user 104 provides vehicle registration and insurance details to government server 108 and insurance server 112. Also, user 104 updates government server 108 and insurance server 112 with vehicle tracking and driver score data (step 306). In one example, user 104 provides DMV information, vehicle registration, proof of insurance, etc. FIG. 6 shows an exemplary interface 600 in which user 104 provides details of each user authorized to operate the vehicle. Further, interface 600 shows insurance coverage details for each user and the vehicle. FIG. 7 shows an exemplary interface 700 presenting vehicle tracking information. Interface 700 shows a route that user 104 currently operating the vehicle took for a period of time. In one example, client device 102 configures to show the route taken by user 104 for a period of past 24 hours. This information allows police 116 to determine user's 104 route took in the past 24 days. FIG. 8 shows an exemplary interface 800 presenting a driver scorecard. In one example, insurance server 112 calculates the driver scorecard based on the user's driving pattern. When needed, client device 102 accesses the information from insurance server 112 and displays the driver scorecard as shown in FIG. 8. Subsequently, client device 102 transmits the information to each of government server 108 and insurance server 112 for storage (step 308).

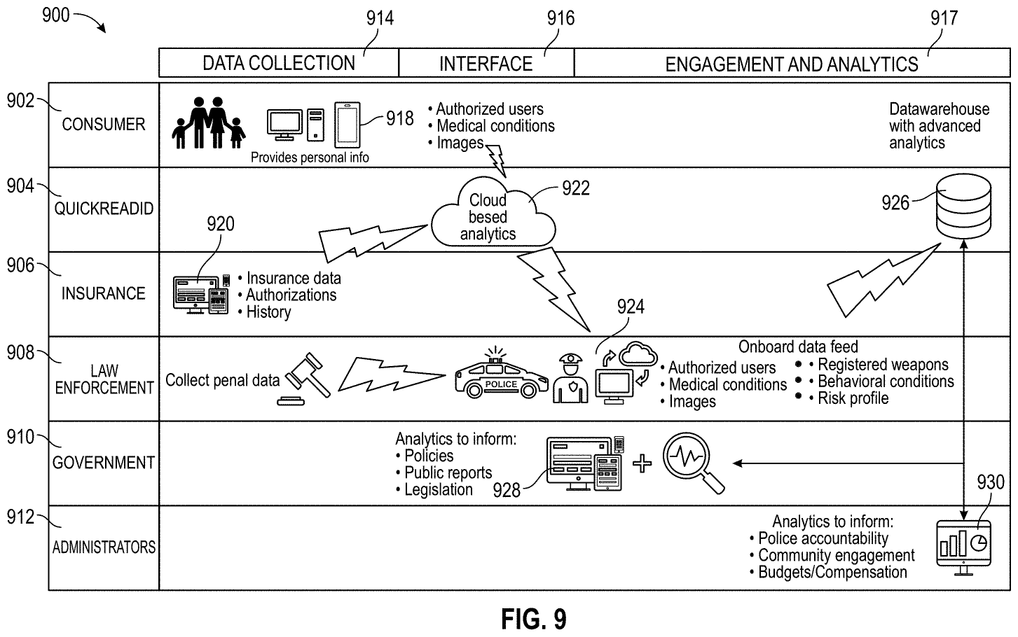

FIG. 9 shows contextual identity information structure 900, in accordance with one embodiment of the present subject matter. Contextual identity information structure 900 includes one or more entities such as customer or user 902. Here, customer 902 subscribes to provide his information to law enforcement officer during law enforcement encounters. As such, customer 902 obtains a unique quick read identification number (QRID) 904. Contextual identity information structure 900 further includes insurance server 906, law enforcement server 908, government server 910. In one example, contextual identity information structure 900 includes administrators to manage the information. Contextual identity information structure 900 collects data 914 from customer 904. In one example, contextual identity information structure 900 provides interface 916 to customer 904 and his family members to provide and access contextual identity information structure 900. In one example, contextual identity information structure 900 allows customer or administrator to generate analytics 917 to manage the data collected and processed in contextual identity information structure 900.

At first, customer 902 provides his information (918) such as name, age, sex, QRID, health information, images, etc. Also, customer 902 provides his family members or other users details authorized to operate the vehicle. In one example, customer 902 provides medical conditions of persons authorized to operate the vehicle. And another example, customer 902 provides similar information regarding the resident in the suspect apartment/dwelling. This way, if any of the authorised persons carry medicines, the data is updated in one of insurance server 906, law enforcement server 908, government server 910. Also, customer 902 uploads images of medicines that authorised users may use to minimize confrontation with the law enforcement officer when he stops them. In one embodiment, insurance server 906 stores data 920 corresponding to customer 902 and any other authorised users. Customer 902 accesses the information 922 when he needs to check status. The information is stored in database 926 such that upon entering QRID 904 corresponding to customer 902 or other authorised users, a law enforcement officer 924 will be able to access the information. Further, when law enforcement officer 924 stops any person driving the vehicle, he accesses data (918 and 922) stored in database 926. In addition, the law enforcement officer accesses government server 910 for legislation or policies (928) to deal with any situation without confronting the person driving the vehicle. Any action taken by law enforcement officer 924 gets stored in database 926. The data allows to check whether law enforcement officer 924 has used excessive force while dealing with a person in the vehicle. In addition, when law enforcement officer 924 access the present system, the user/owner of the system receives a text from the system that the law enforcement officer has accessed the present system. This also allows the government to take necessary steps to reduce or minimize confrontations by law enforcement officers and/or people during law enforcement encounters.

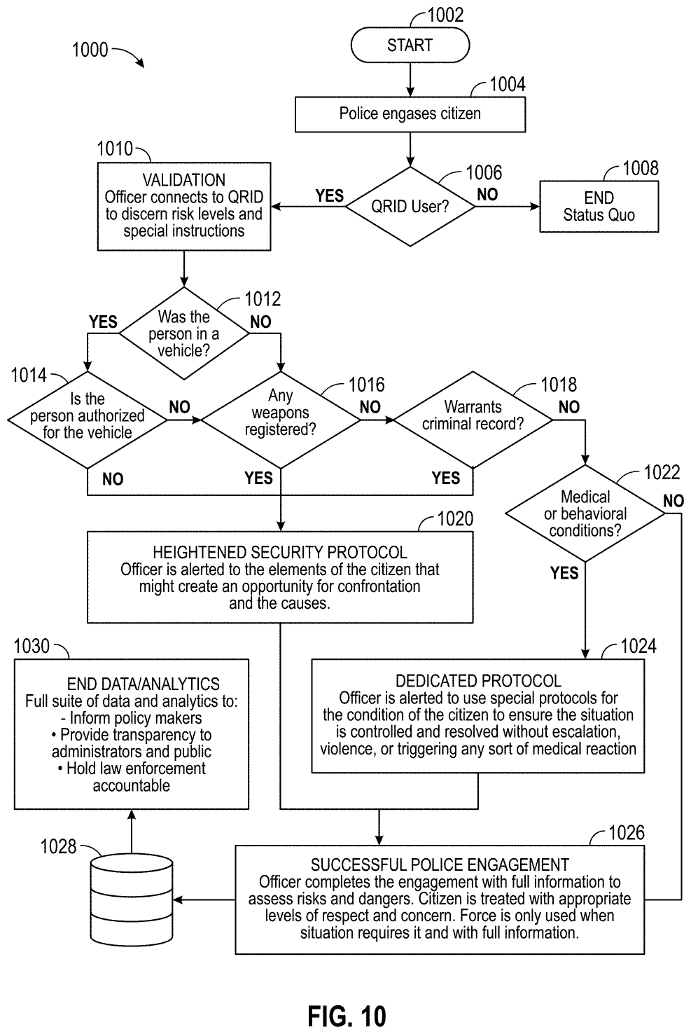

FIG. 10 shows method 1000 of verifying the details of the user and the vehicle or dwelling by a law enforcement officer using a quick read unique identification number (QRID) generated for customer and other users to operate the vehicle, in accordance with one exemplary embodiment of the present subject matter. The order in which method 1000 is described should not be construed as a limitation, and any number of the described method blocks can be combined in any order to implement method 1000 or alternate methods. Additionally, individual blocks may be deleted from method 1000 without departing from the spirit and scope of the subject matter described herein. Furthermore, method 1000 can be implemented in any suitable hardware, software, firmware, or combination thereof. However, for ease of explanation, in the embodiments described below, method 1000 may be implemented using law enforcement device 116 (also 924).

A person skilled in the art understands that a law enforcement officer uses a law enforcement device to verify the details of the user and/or vehicle/dwelling when the law enforcement officer stops the user's vehicle at the side of the road. In one example, the law enforcement officer may stop the user on suspicion of vehicle theft. In another example, the law enforcement officer may stop a user on suspicion of driving without proper documentation, say insurance or license. In another example, a law enforcement officer may stop a user on a routine check. In another example, a law enforcement officer may stop a user for driving in the wrong direction or for violating traffic rules. A person skilled in the art understands that a law enforcement officer may stop a user or, with a valid search warrant, request entry to a dwelling for any other reason.

Method 1000 starts at step 1002. At step 1004, a law enforcement officer stops and engages a citizen or user. Here, the law enforcement officer checks if the citizen has QRID (QRID) (1006). If the citizen does not have QRID, then method 1000 ends and the law enforcement officer follows the traditional method of dealing with the citizen (step 1008). If the citizen has QRID, method 1000 proceeds to step 1010. At step 1010, the law enforcement officer connects to QRID to discern the risk level posed by the citizen or any special instructions provided for the specific citizen. At step 1012, the law enforcement officer checks if the citizen having QRID is same person in the vehicle (step 1012). If yes, then the law enforcement officer checks whether the person is authorised for the vehicle (step 1014). If the person is not authorised for the vehicle, then method 1000 moves to steps 1016 & 1020. If at step 1012, it is determined that the citizen is not the person as identified based on the QRID, then method 1000 moves to step 1016. At step 1016, the law enforcement officer checks if a weapon is registered for the person in the vehicle. If yes (1016), then method 1000 moves to step 1020. If not (1016), then method 1000 moves to step 1018. At step 1018, the law enforcement officer checks if the person warrants a criminal record. If yes (1018), the method 1000 moves to step 1020. At step 1020, the law enforcement officer is alerted to the elements of the citizen that might create an opportunity for confrontation and the possible causes.

If there is no criminal record (step 1018), then the citizen's medical or behavioural conditions are checked at step 1022. If the citizen has medical or behavioural conditions, then the law enforcement officer is alerted to use special protocols based on the condition of the citizen to ensure the situation is controlled and resolved without escalation, violence, or triggering any sort of medical reaction (step 1024). If there are medical conditions (step 1022) or upon alerting the law enforcement officer to deal with the situation, then method 1000 moves to step 1026. At step 1026, the law enforcement officer completes the engagement with full information to assess risks and dangers. The law enforcement officer treats the person with appropriate levels of respect and concern. Here, the law enforcement officer uses force only when situation requires and with full information thereby minimizing the confrontational tensions with the citizen. The information corresponding to how the law enforcement officer dealt with the person is stored in a database (step 1028). The method 1000 ends at step 1030 where reports or analytics are generated/prepared to inform policy makers to enact new legislation or modify existing laws. The analytics provide transparency to administrators and the public. If it is determined that the law enforcement officer acted inappropriately, then the law enforcement officer may be held accountable for causing confrontational tension with the citizen.

Based on the above, it is evident that the presently disclosed system provides the information to the law enforcement officer and allows to reduce potentially hostile situations, by putting the law enforcement official at ease. The system provides complete information about the users to the law enforcement official and helps to reduce the initial confrontational tension between the law enforcement officer and the users. This results in the users or drivers likelihood of putting the law enforcement official in a potentially dangerous situation. Further, this causes the law enforcement official to be less likely to harm the users/drivers.

The present subject matter has been described in particular detail with respect to various possible embodiments, and those of skill in the art will appreciate that the subject matter may be practiced in other embodiments. First, the particular naming of the components, capitalization of terms, the attributes, data structures, or any other programming or structural aspect is not mandatory or significant, and the mechanisms that implement the subject matter or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

Some portions of the above description present the features of the present subject matter in terms of algorithms and symbolic representations of operations on information. These algorithmic descriptions and representations are the means used by those skilled in the data processing arts to most effectively convey the substance of their work to others skilled in the art. These operations, while described functionally or logically, should be understood as being implemented by computer programs.

Further, certain aspects of the present subject matter include process steps and instructions described herein in the form of an algorithm. It should be noted that the process steps and instructions of the present subject matter could be embodied in software, firmware, or hardware, and when embodied in software, could be downloaded to reside on and be operated from different platforms used by real-time network operating systems.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. Also, the present subject matter is not described with reference to any particular programming language. It is appreciated that a variety of programming languages may be used to implement the teachings of the present subject matter as described herein, and any references to specific languages are provided for disclosure of enablement and best mode of the present subject matter.

It should be understood that components shown in FIGUREs are provided for illustrative purposes only and should not be construed in a limited sense. A person skilled in the art will appreciate alternate components that may be used to implement the embodiments of the present subject matter and such implementations will be within the scope of the present subject matter.

While preferred embodiments have been described above and illustrated in the accompanying drawings, it will be evident to those skilled in the art that modifications may be made without departing from this subject matter. Such modifications are considered as possible variants included in the scope of the subject matter.

We claim:

1. We claim the above subject matter as presented.
